(19) United States
(12) Patent Application Publication
(10) Pub. No.: US 2017/0308790 A1
(43) Pub. Date: Oct. 26, 2017

(54) TEXT CLASSIFICATION BY RANKING WITH CONVOLUTIONAL NEURAL NETWORKS

(71) Applicant: International Business Machines Corporation, Armonk, NY (US)

(72) Inventors: Cicero Nogueira dos Santos, White Plains, NY (US); Bing Xiang, Mount Kisco, NY (US); Bowen Zhou, Somers, NY (US)

(21) Appl. No.: 15/134,719

(22) Filed: Apr. 21, 2016

(51) Int. Cl. G06N 3/08; G06N 99/00

(52) U.S. Cl. CPC G06N 3/088; G06N 99/005

(57) ABSTRACT

According to an aspect a method includes configuring a convolutional neural network (CNN) for classifying text based on word embedding features into a predefined set of classes identified by class labels. The predefined set of classes includes a class labeled none-of-the-above for text that does not fit into any of the other classes in the predefined set of classes. The CNN is trained based on a set of training data. The training includes learning parameters of class distributed vector representations (DVRs) of each of the predefined set of classes. The learning includes minimizing a pair-wise ranking loss function over the set of training data. A class embedding matrix of the class DVRs of the predefined set of classes that excludes a class embedding for the none-of-the-above class is generated. Each column in the class embedding matrix corresponds to one of the predefined classes.

### BACKGROUND

The present disclosure relates generally to natural language processing, and more specifically, to text classification.

Text classification is a natural language processing (NLP) task which is often used as an intermediate step in many complex NLP applications such as question-answering. Given a string of text and a predefined set of classes identified by class labels, the aim of text classification is to predict the class label that should be assigned to the text. The string of text can be a phrase, a sentence, a paragraph, or a whole document. There has been an increasing interest in applying machine learning approaches to text classification. In particular the task of classifying the relationship between nominals that appear in a sentence has gained a lot of attention recently. One reason for this increased interest is the availability of benchmark datasets such as SemEval 2010-task 8 which encodes the task of classifying the relationship between two nominals marked in a sentence.

Some recent work on text classification has focused on the use of deep neural networks with the aim of reducing the number of handcrafted features. These approaches still use some features derived from lexical resources such as Word-Net® or NLP tools such as dependency parsers and named entity recognizers (NERs).

### SUMMARY

Embodiments include a method, system, and computer program product for test classification by ranking with convolutional neural networks (CNNs). The method includes configuring a CNN for classifying text based on word embedding features into a predefined set of classes identified by class labels. The predefined set of classes includes a class labeled none-of-the-above for text that does not fit into any of the other classes in the predefined set of classes. The configuring includes receiving a set of training data that includes for each training round: training text, a correct class label that correctly classifies the training text, and an incorrect class label that incorrectly classifies the training text. The correct class label and the incorrect class label are selected from the class labels that identify the predefined set of classes. The CNN is trained based on the set of training data. The training includes learning parameters of class distributed vector representations (DVRs) of each of the predefined set of classes. The learning includes minimizing a pair-wise ranking loss function over the set of training data and causing the CNN to generate: a score of less than zero in response to a correct class label of none-of-the-above, and a score of greater than zero in response to a correct class label having any other value; and a score of less than zero in response to an incorrect class label. A class embedding matrix of the class DVRs of the predefined set of classes that excludes a class embedding for the none-of-the-above class is generated. Each column in the class embedding matrix corresponds to one of the predefined classes. This can provide for building a CNN that reduces the impact of an artificial, or none-of-the-above class, on text classification.

In an embodiment, the score that is greater than zero is greater than zero by a first specified margin magnified by a scaling margin and the score that is less than zero is less than zero by a second specified margin magnified by the scaling margin. This can provide for a magnified difference between the scores and helps to penalize more on the prediction errors, or incorrect class label.

In an embodiment, stochastic gradient descent with back propagation is used to update the parameters. This can provide for updates to the CNN parameters during the training.

In an embodiment, input features to the CNN include word embeddings of one or more words in each set of training text. This can provide for input that is automatically learned using neural language models.

In an embodiment, the set of classes include relations between nouns in the input text. This can provide for the classification of a relationship between two nouns in a sentence.

In an embodiment, the set of classes include sentiments of the input text. This can provide for the classification of a sentiment of a text segment.

In an embodiment, a text string is received by the CNN and a class label of the text string is predicted. This can provide for predicting a class label of a text string using a CNN that reduces the impact of an artificial, or none-of-the-above class, on text classification.

In an embodiment, predicting the class label of the text string includes: generating a DVR of the text string; comparing the DVR of the text string to the class DVRs in the class embedding matrix to generate a score for each of the classes corresponding to columns in the class embedding matrix; and selecting the highest generated score. The predicting further includes, based on the selected score being greater than zero, outputting the class label corresponding to the selected score as the predicted class label of the text string. The predicting further includes, based on the selected score being less than or equal to zero, outputting the class label of none-of-the-above as the predicated class label of the text string. This can provide for predicting a class label of a text string using a CNN that reduces the impact of an artificial, or none-of-the-above class, on text classification.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts components of a system for text classification by ranking in accordance with one or more embodiments;

FIG. 2 depicts a neural network for text classification by ranking in accordance with one or more embodiments;

FIG. 3 depicts a flow diagram of a process for creating a model for text classification by ranking in accordance with one or more embodiments;

FIG. 4 depicts a flow diagram of a process for performing text classification by ranking in accordance with one or more embodiments; and

FIG. 5 depicts a processing system for text classification by ranking in accordance with one or more embodiments.

### DETAILED DESCRIPTION

Embodiments described herein are directed to performing text classification by utilizing a convolutional neural network (CNN) along with a pair-wise ranking loss function that reduces the impact of artificial classes on the classification. Embodiments of the ranking loss function allow explicit handling of the common situation where there is an artificial “none-of-the-above”, or “other” class which typically is noisy and difficult to handle. Given a string of text as input, one or more embodiments described herein produce a ranking of class labels contained in a predefined set of class labels, with the class label having the highest ranking being the predicted class for the string of text. In one or more embodiments, if a score of the highest ranking class label is less than zero, then the predicted class for the string of text is the none-of-the-above class which is used to indicate that the string of text does not belong to any of the other predefined classes.

One or more embodiments utilize a new type of CNN, referred to herein as a classification by ranking CNN (CR-CNN) that uses only word embeddings as input features to perform text classification. As used herein, the term “word embedding” refers to a parameterized function that maps words to multi-dimensional vectors, where semantically similar words are mapped to nearby points based on the idea that words that appear in the same contexts share semantic meaning. Word embeddings can be automatically learned by applying neural language models to large amount of texts and are therefore much cheaper to produce than handcrafted features. A neural language model consists in a neural network that, given a sequence of words as input, it returns as output a probability distribution over the words in the vocabulary. The probability associated to each word indicates how likely the word would follow the input sequence in a text.

One or more embodiments of the CR-CNN described herein learn a class embedding, also referred to herein as a “distributed vector representation (DVR)”, for each class in a predefined set of class labels. Once the CR-CNN has been trained, embodiments of the CR-CNN produce a DVR of an input text string, which is then compared to the DVRs of each of the classes in order to produce a score for each predefined relation class. Embodiments described herein also utilize a new pairwise ranking loss function that can reduce the impact of artificial classes, such as the none-of-the-above class, on the scoring and predicting of class labels for input text.

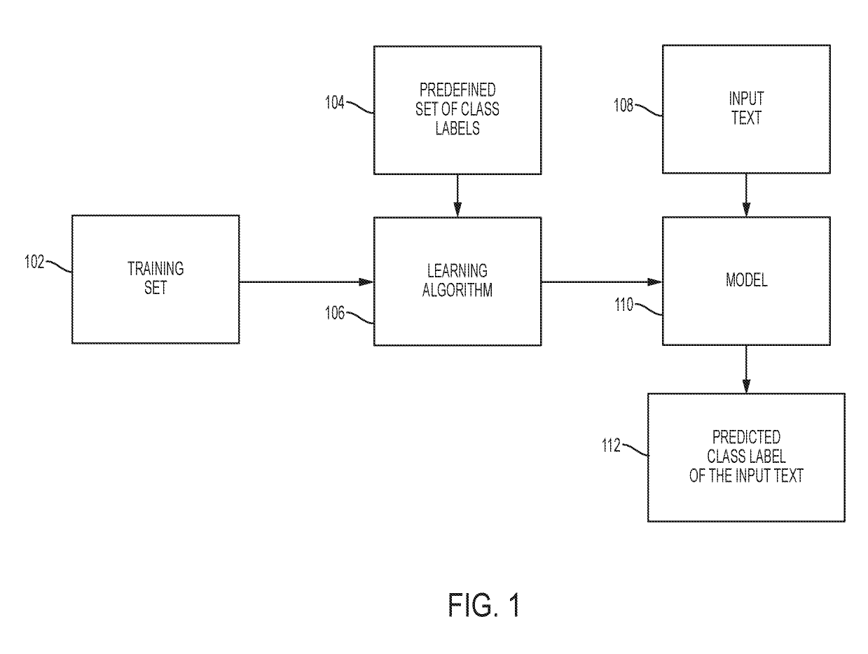

Turning now to FIG. 1, components of a system for text classification are generally shown in accordance with one or more embodiments. As shown in FIG. 1, a training set 102 that includes training data is input to a learning algorithm 106 along with a predefined set of class labels 104 to train a model 110. In an embodiment, the learning algorithm 106 includes a CR-CNN to learn a class embedding matrix based on word embedding features of the training data. Also shown in FIG. 1 is input text 108 that is input to the model 110 to generate a predicted class label of the input text 112. In an embodiment, the model 110 includes the trained CR-CNN including the class embedding matrix which is compared to a DVR of the input text 108 to generate the predicted class label of the text 112.

An example of text classification that classifies a relationship between two nouns in a sentence is utilized herein to describe aspects of embodiments. Embodiments described herein are not limited to this example, and can be applied to any type of text classification such as, but not limited to sentiment classification, question type classification and dialogue act classification.

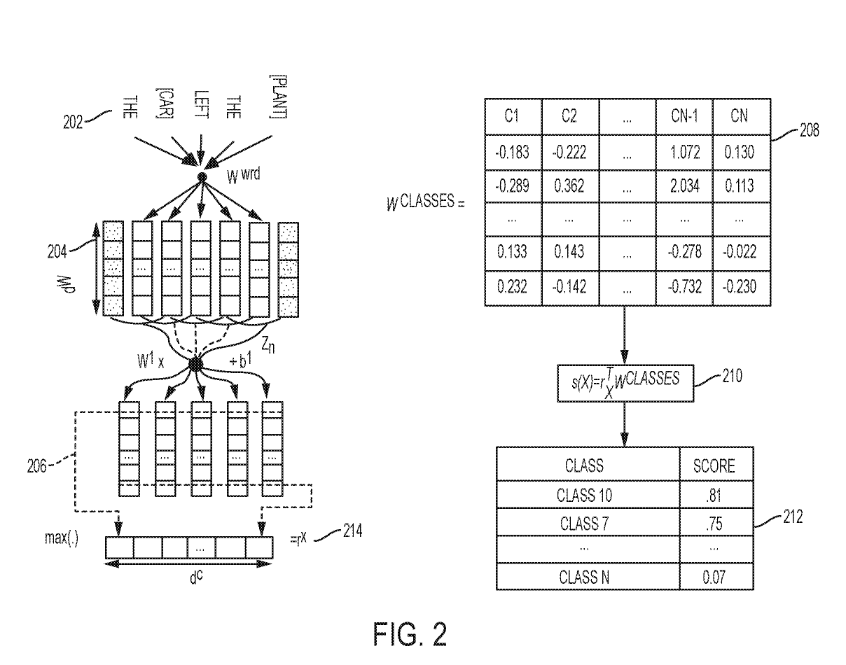

Turning now to FIG. 2, a convolutional neural network for classification by ranking, referred to herein as a CR-CNN, is generally shown in accordance with one or more embodiments. As shown in FIG. 2, the input text 108 includes a sentence “x” 202 that has two target nouns “car” and “plant.” The task includes classifying the relation between the two nominals (e.g. the two target nouns). In accordance with one or more embodiments, the CR-CNN computes a score for each relation class “c” which is within the predefined set of class labels 104, also referred to herein as “C”. For each class cεC, the CR-CNN learns a DVR which can be encoded as a column in a class embedding matrix, shown as W^{classes} 208 in FIG. 2. As shown in FIG. 2, the only input for the CR-CNN is the tokenized text string of the sentence “x” 202. The CR-CNN transforms words in the sentence “x” 202 into real-valued feature vectors 204. A convolutional layer of the CR-CNN uses the real-valued feature vectors 204 to construct a DVR of the sentence, rₓ 214, and the CR-CNN computes a score 212 for each relation class cεC by performing a dot product 210 between rₓ and W^{classes} 208. The relation class having the highest score can then be output as the predicted class label of the sentence “x” 202. In this example, the predefined set of class labels 104 are relations between the nouns and can include, but not limited to: cause-effect, component-whole, content-container, entity-destination, entity-origin, instrument-agency, member-collection, message-topic, product-producer, and other.

A first layer of an embodiment of the CR-CNN creates word embeddings by transforming words in the sentence x 202 into representations that capture syntactic and semantic information about the words. If sentence x 202 contains “N” words, then x={w₁, w₂, . . . , w_{N}} and every word wₙ is converted into a real-valued vector r^{wn}. Therefore, the input to the next layer is a sequence of real-value feature vectors 204 that can be denoted as embₓ=(r^{w1}, r^{w2}, . . . , r^{wN}).

Word representations can be encoded by column vectors in an embedding matrix W^{wrd}ε [symbol] ^{d}^{^{w}}^{×|V|}, where V is a fixed-sized vocabulary. Each column Wᵢ^{wrd}ε [symbol] ^{d}^{^{w}} corresponds to the word embedding of the i-th word in the vocabulary. A word w is transformed into its word embedding r^{w} by using the matrix-vector product:

r^{w}=W^{wrd}v^{w}

where v^{w} is a vector of size |V| which has value 1 at index w and zero in all other positions. The matrix W^{wrd} is a parameter to be learned, and the size of the word embedding d^{w} is a hyperparameter to be chosen by the user.

In the example described herein, information that is needed to determine the class of a relation between two target nouns normally comes from words which are close to the target nouns. Contemporary methods utilize position features such as word position embeddings (WPEs) which help the CR-CNN by keeping track of how close words are to the target nouns. In an embodiment, the WPE is derived from the relative distance of the current word to the target noun₁ and noun₂. For instance, in the sentence shown in FIG. 2, the relative distances of left to car and plant are −1 and 2, respectively. In embodiments, each relative distance is mapped to a vector of dimension d^{wpe}, which is initialized with random numbers. d^{wpe} is a hyperparameter of the network. Given the vectors wp₁ and wp₂ for the word w with respect to the targets noun₁ and noun₂, the position embedding of w is given by the concatenation of these two vectors, wpe^{w}=[wp₁, wp₂].

In embodiments where word position embeddings are used, the word embedding and the word position embedding of each word can be concatenated to form the input for the convolutional layer, embₓ={[r^{w1}, wpe^{w1}], [r^{w2}, wpe^{w2]}, . . . , [r^{wN}, wpe^{wN}]}.

The CR-CNN then creates the DVR, rₓ 214, for the input sentence x 202. Embodiments account for sentence size variability and that important information can appear at any position in the sentence. In contemporary work, convolutional approaches have been used to tackle these issues when creating representations for text segments of different sizes and character level representations of words of different sizes. In embodiments described herein, a convolutional layer is utilized to compute DVRs of the sentence. An embodiment of the convolutional layer first produces local features around each word in the sentence, and then it combines these local features using a max operation to create a fixed-sized vector for the input sentence.

Given a sentence x 202, the CR-CNN can apply a matrix-vector operation to each window of size k 204 of successive windows in embₓ={r^{w1}, r^{w2}, . . . , r^{wN}}. The vector:

zₙε [symbol] ^{d}^{^{w}}^{b}

can be defined as the concatenation of a sequence of k word embeddings, centralized in the n-th word:

zₙ=(r^{w}^{_{n−(k-1)/2}}, . . . , r^{w}^{_{n+(k-1)/2}})^{T}

In order to overcome the issue of referencing words with indices outside of the sentence boundaries, the sentence can be augmented with a special padding token replicated (k−1)/2 times at the beginning and the end.

The convolutional layer in the CR-CNN can compute the j-th element of the vector rₓε [symbol] ^{d}^{^{w}} 214 as follows:

$${[ {r}_{x} ]}_{j} = {max}_{1 < n < N} {[ f ( {W}^{1} {z}_{n} + {b}^{1} ) ]}_{j}$$

where W¹ε [symbol] ^{d}^{^{w}}^{×d}^{^{w}}^{k} is the weight matrix of the convolutional layer and f is the hyperbolic tangent function. The same matrix can be used to extract local features around each word window of the given sentence x 202. The fixed-sized DVR for the sentence can be obtained by using the maximum over all word windows. Matrix W¹ and vector b¹ are parameters to be learned. The number of convolutional units, d^{c}, and the size of the word context window k are hyper parameters to be chosen by the user. Note that d^{c} corresponds to the size of the sentence representation.

In an embodiment, given the DVR of the input sentence x 202, the CR-CNN with parameter set θ computes the score for a class label cεC by using the dot product

s_{θ}(x)_{c}=rₓ^{T}[W^{classes}]_{c}

where W^{classes} 208 is an embedding matrix whose columns encode the DVRs of the different class labels, and [W^{classes}]_{c} is the column vector that contains the embedding of the class c. In embodiments, the number of dimensions in each class embedding is equal to the size of the sentence representation, which is defined by d^{c}. The embedding matrix W^{classes} 208 is a parameter to be learned by the CR-CNN, and it can be initialized by randomly sampling each value from a uniform distribution:

$$𝒰 ( - r , r ) , where r = \sqrt{\frac{6}{\vert C \vert + {d}^{c}}}$$

In an embodiment, the CR-CNN is trained by the learning algorithm 106, by minimizing a pairwise ranking loss function over the training set D. The input for each training round is a sentence x and two different class labels y+εC and c⁻εC, where y+ is a correct class label for x and c⁻ is not. Let s_{θ}(x)_{y+} and s_{θ}(x)_{c}− be respectively the scores for class labels y+ and c⁻ generated by then CR-CNN with parameter set θ. Embodiments utilize a new logistic loss function over these scores in order to train CR-CNN:

L=log(1+exp(γ(m⁺−s_{θ}(x)_{y}_{⁺}))

+log(1+exp(γ(m⁻¹+s_{θ}(x)_{c}_{^{−}})) (Equation 1)

where m+ and m− are margins and γ is a scaling factor that magnifies the difference between the score and the margin, and helps to penalize more on the prediction errors. The first term in the right side of Equation 1 decreases as the score s_{θ}(x)_{y+} increases. The second term in the right side decreases as the score s_{θ}(x)_{c}− decreases. Training CR-CNN by minimizing the loss function in Equation 1 has the effect of training to give scores greater than m+ for the correct class and (negative) scores smaller than −m⁻ for incorrect classes.

In embodiments, L2 regularization can be used by adding the term β∥θ∥² to Equation 1. In embodiments, stochastic gradient descent (SGD) can be utilized to minimize the loss function with respect to θ.

Like some other ranking approaches that only update two classes/examples at every training round, embodiments can efficiently train the network for tasks which have a very large number of classes. On the other hand, sampling informative negative classes/examples can have a significant impact in the effectiveness of the learned model. In the case of the loss function described herein, more informative negative classes are the ones with a score larger than −m⁻. In embodiments where the number of classes in the text classification dataset is small, given a sentence x with class label y+, the incorrect class c chosen to perform a SGD step can be the one with the highest score among all incorrect classes:

$${c}^{-} = {arg min}_{c ∈ C ; c \neq {y}^{+}} {{s}_{θ} ( x )}_{c} .$$

For tasks where the number of classes is large, a number of negative classes to be considered at each example can be fixed and the one with the largest score can be selected to perform a stochastic gradient descent step.

In embodiments a stochastic gradient descent with back propagation algorithm can be used to compute gradients of the neural network.

In embodiments, a class is considered artificial if it is used to group items that do not belong to any of the actual classes. An example of artificial class is the class “Other” in the SemEval 2010 relation classification task, where the class Other is used to indicate that the relation between two nominals does not belong to any of the nine relation classes of interest. Therefore, the class Other is very noisy since it groups many different types of relations that may not have much in common. The class Other can also be referred to herein as the class none-of-the-above.

Embodiments of the CR-CNN described herein make it easy to reduce the effect of artificial classes by omitting their embeddings. If the embedding of a class label c is omitted, it means that the embedding matrix W^{classes} 208 does not contain a column vector for c. A benefit from this strategy is that the learning process focuses on the “natural” classes only. Since the embedding of the artificial class is omitted, it will not influence the prediction step, that is, CR-CNN does not produce a score for the artificial class.

In embodiments, when training with a sentence x whose class label y=Other, the first term in the right side of Equation 1 is set to zero. During prediction time, a relation is classified as Other only if all actual classes have negative scores. Otherwise, it is classified with the class which has the largest score.

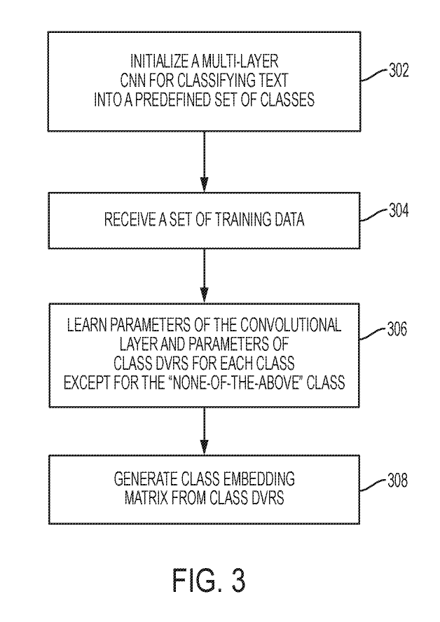

Turning now to FIG. 3, a flow diagram of a process for creating a model for text classification is generally shown in accordance with one or more embodiments. At block 302, the CR-CNN for classifying text based on word embedding features into a predefined set of classes identified by class labels is initialized. In embodiments, the predefined set of classes includes a class labeled none-of-the-above for text that does not fit into at least one other class in the predefined set of classes, that is, it is an artificial class. At block 304, a set of training data is received that includes, for each training round, training text (e.g., a text string that represents a sentence or paragraph), a correct class label for the training text, and an incorrect class label for the training text. The training data can be manually generated and/or it can automatically generated, for example, as the sub-product of another activity.

At block 306, the CR-CNN is trained using contents of the set of training data. The training can include learning the parameters of the convolutional layer (e.g., W¹ and b¹ in FIG. 2) as well as the parameters of class DVRs for each of the predefined set of classes. In embodiments, the learning includes minimizing a pair-wise ranking loss function over the set of training data. In embodiments, the CR-CNN is trained to generate a score of greater than zero in response to the training text being paired with a correct class label having any value other than none-of-the-above; and to generate a score of less than zero in response to the training text being paired with an incorrect class label. Training texts that belong to the class label of none-of-the-above can be paired with incorrect labels only, i.e., only with labels other then the none-of-the-above label. In embodiments, the score that is greater than zero is greater than zero by a first specified margin that may also be magnified by a first scaling margin. In one or more embodiments, the score that is less than zero is less than zero by a second specified margin that may also be magnified by a second scaling margin.

In one or more embodiments, input features to the CR-CNN include word embeddings of one or more words in the training text.

The class DVRs can be initialized with random numbers which are uniformly sampled from the interval [−0.01,0.01]. The class DVRs, together with the parameters of the convolutional layer can be iteratively learned by using the stochastic gradient descendent algorithm.

Referring back to box 308 of FIG. 3, a class embedding matrix that includes the class DVRs of the predefined set of classes is generated. In an embodiment, each column in the class embedding matrix corresponds to one of the predefined classes, except for the none-of-the-above class. As a class DVR is not trained for the none-of-the-above class, it will not contain a respective column in the class embedding matrix. Therefore, the none-of-the-above class will not influence the prediction step because the neural network does not try to produce a score for this artificial class.

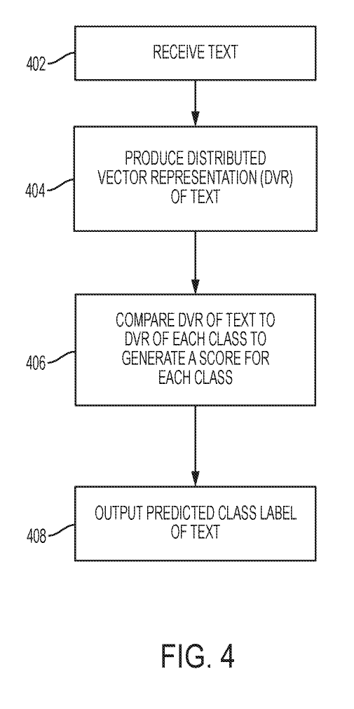

Turning now to FIG. 4, a flow diagram of a process for predicting a class label of a text string is generally shown in accordance with one or more embodiments. At block 402, input text 108 is received by the CR-CNN, such as the model 110 shown in FIG. 1. At block 404, the CR-CNN generates a DVR based on the input text 108. The DVR generated based on the input text is compared at block 406 to each of the class DVRs to generate a score for each class. One possible comparison method includes performing the dot product between the two DVRs, which will produce a high score if the magnitude of the values in corresponding positions of the two DVRs are high and have the same sign. At block 408, the predicted class label of the text is output. In one or more embodiments, the class with the highest score is selected as the predicted class label when the highest score is greater than zero. When the highest score is zero or less than zero, the class label of none-of-the-above is selected as the predicated class label of the text string.

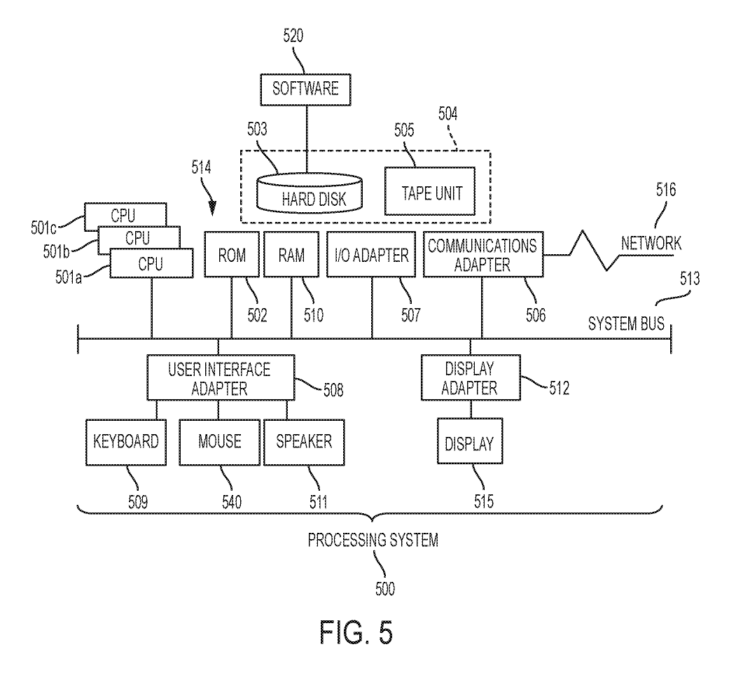

Turning now to FIG. 5, a processing system 500 for text classification is generally shown in accordance with one or more embodiments. In this embodiment, the processing system 500 has one or more central processing units (processors) 501a, 501b, 501c, etc. (collectively or generically referred to as processor(s) 501). Processors 501, also referred to as processing circuits, are coupled to system memory 514 and various other components via a system bus 513. Read only memory (ROM) 502 is coupled to system bus 513 and may include a basic input/output system (BIOS), which controls certain basic functions of the processing system 500. The system memory 514 can include ROM 502 and random access memory (RAM) 510, which is read-write memory coupled to system bus 513 for use by processors 501.

FIG. 5 further depicts an input/output (I/O) adapter 507 and a network adapter 506 coupled to the system bus 513. I/O adapter 507 may be a small computer system interface (SCSI) adapter that communicates with a hard disk 503 and/or tape storage drive 505 or any other similar component. I/O adapter 507, hard disk 503, and tape storage drive 505 are collectively referred to herein as mass storage 504. Software 520 for execution on processing system 500 may be stored in mass storage 504. The mass storage 504 is an example of a tangible storage medium readable by the processors 501, where the software 520 is stored as instructions for execution by the processors 501 to perform a method, such as the process flow of FIGS. 3 and 4. Network adapter 506 interconnects system bus 513 with an outside network 516 enabling processing system 500 to communicate with other such systems. A screen (e.g., a display monitor) 515 is connected to system bus 513 by display adapter 512, which may include a graphics controller to improve the performance of graphics intensive applications and a video controller. In one embodiment, adapters 507, 506, and 512 may be connected to one or more I/O buses that are connected to system bus 513 via an intermediate bus bridge (not shown). Suitable I/O buses for connecting peripheral devices such as hard disk controllers, networks, and graphics adapters typically include common protocols, such as the Peripheral Component Interconnect (PCI). Additional input/output devices are shown as connected to system bus 513 via user interface adapter 508 and display adapter 512. A keyboard 509, mouse 540, and speaker 511 can be interconnected to system bus 513 via user interface adapter 508, which may include, for example, a Super I/O chip integrating multiple device adapters into a single integrated circuit.

Thus, as configured in FIG. 5, processing system 500 includes processing capability in the form of processors 501, and, storage capability including system memory 514 and mass storage 504, input means such as keyboard 509 and mouse 540, and output capability including speaker 511 and display 515. In one embodiment, a portion of system memory 514 and mass storage 504 collectively store an operating system to coordinate the functions of the various components shown in FIG. 5.

Technical effects and benefits include the ability to employ neural networks to convert text to DVRs which are then used to perform text classification. In embodiments, described herein, the classes are modeled as embeddings (DVRs) whose values are learned by the CR-CNN. Embodiments can be utilized to deal with the “none-of-the-above” class by using the pairwise ranking loss function described herein.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
configuring a convolutional neural network (CNN) for classifying text based on word embedding features into a predefined set of classes identified by class labels, the predefined set of classes including a class that is labeled none-of-the-above for text that does not fit into any of the other classes in the predefined set of classes, the configuring comprising:
receiving a set of training data that includes for each training round: training text, a correct class label that correctly classifies the training text, and an incorrect class label that incorrectly classifies the training text, the correct class label and the incorrect class label selected from the class labels that identify the predefined set of classes;
training the CNN based on the set of training data, the training including:
learning parameters of class distributed vector representations (DVRs) of each of the predefined set of classes, the learning including minimizing a pair-wise ranking loss function over the set of training data and causing the CNN to generate:
a score of less than zero in response to a correct class label of none-of-the-above, and a score of greater than zero in response to a correct class label having any other value; and
a score of less than zero in response to an incorrect class label; and
generating a class embedding matrix of the class DVRs of the predefined set of classes that excludes a class embedding for the none-of-the-above class, each column in the class embedding matrix corresponding to one of the predefined classes.

2. The method of claim 1, wherein the score that is greater than zero is greater than zero by a first specified margin magnified by a scaling margin and the score that is less than zero is less than zero by a second specified margin magnified by the scaling margin.

3. The method of claim 1, wherein stochastic gradient descent with back propagation is used to update the parameters.

4. The method of claim 1, wherein input features to the CNN include word embeddings of one or more words in each set of training text.

5. The method of claim 1, wherein the set of classes include relations between nouns in the input text.

6. The method of claim 1, wherein the set of classes include sentiments of the input text.

7. The method of claim 1, further comprising:
receiving, by the CNN, a text string;
predicting, by the CNN, a class label of the text string.

8. The method of claim 7, wherein the predicting comprises:
generating a DVR of the text string;
comparing the DVR of the text string to the class DVRs in the class embedding matrix to generate a score for each of the classes corresponding to columns in the class embedding matrix;
selecting the highest generated score;
based on the selected score being a positive number, outputting the class label corresponding to the selected score as the predicted class label of the text string; and
based on the selected score being a negative number, outputting the class label of none-of-the-above as the predicated class label of the text string.

9. A system comprising:
a memory having computer readable computer instructions; and
a processor for executing the computer readable instructions, the computer readable instructions including:
configuring a convolutional neural network (CNN) for classifying text based on word embedding features into a predefined set of classes identified by class labels, the predefined set of classes including a class that is labeled none-of-the-above for text that does not fit into any of the other classes in the predefined set of classes, the configuring comprising:
receiving a set of training data that includes for each training round: training text, a correct class label that correctly classifies the training text, and an incorrect class label that incorrectly classifies the training text, the correct class label and the incorrect class label selected from the class labels that identify the predefined set of classes;
training the CNN based on the set of training data, the training including:
learning parameters of class distributed vector representations (DVRs) of each of the predefined set of classes, the learning including minimizing a pair-wise ranking loss function over the set of training data and causing the CNN to generate:
a score of less than zero in response to a correct class label of none-of-the-above, and a score of greater than zero in response to a correct class label having any other value; and
a score of less than zero in response to an incorrect class label; and
generating a class embedding matrix of the class DVRs of the predefined set of classes that excludes a class embedding for the none-of-the-above class, each column in the class embedding matrix corresponding to one of the predefined classes.

10. The system of claim 9, wherein the score that is greater than zero is greater than zero by a first specified margin magnified by a scaling margin and the score that is less than zero is less than zero by a second specified margin magnified by the scaling margin.

11. The system of claim 9, wherein stochastic gradient descent with back propagation is used to update the parameters.

12. The system of claim 9, wherein input features to the CNN include word embeddings of one or more words in each set of training text.

13. The system of claim 9, wherein the instructions further include:
receiving, by the CNN, a text string;
predicting, by the CNN, a class label of the text string.

14. The system of claim 13, wherein the predicting comprises:
generating a DVR of the text string;
comparing the DVR of the text string to the class DVRs in the class embedding matrix to generate a score for each of the classes corresponding to columns in the class embedding matrix;
selecting the highest generated score;
based on the selected score being a positive number, outputting the class label corresponding to the selected score as the predicted class label of the text string; and
based on the selected score being a negative number, outputting the class label of none-of-the-above as the predicated class label of the text string.

15. A computer program product comprising:
a tangible storage medium readable by a processor and storing instructions executable by the processor for:
configuring a convolutional neural network (CNN) for classifying text based on word embedding features into a predefined set of classes identified by class labels, the predefined set of classes including a class that is labeled none-of-the-above for text that does not fit into any of the other classes in the predefined set of classes, the configuring comprising:
receiving a set of training data that includes for each training round: training text, a correct class label that correctly classifies the training text, and an incorrect class label that incorrectly classifies the training text, the correct class label and the incorrect class label selected from the class labels that identify the predefined set of classes;
training the CNN based on the set of training data, the training including:
learning parameters of class distributed vector representations (DVRs) of each of the predefined set of classes, the learning including minimizing a pair-wise ranking loss function over the set of training data and causing the CNN to generate:
a score of less than zero in response to a correct class label of none-of-the-above, and a score of greater than zero in response to a correct class label having any other value; and
a score of less than zero in response to an incorrect class label; and
generating a class embedding matrix of the class DVRs of the predefined set of classes that excludes a class embedding for the none-of-the-above class, each column in the class embedding matrix corresponding to one of the predefined classes.

16. The computer program product of claim 15, wherein the score that is greater than zero is greater than zero by a first specified margin magnified by a scaling margin and the score that is less than zero is less than zero by a second specified margin magnified by the scaling margin.

17. The computer program product of claim 15, wherein stochastic gradient descent with back propagation is used to update the parameters.

18. The computer program product of claim 15, wherein input features to the CNN include word embeddings of one or more words in each set of training text.

19. The computer program product of claim 15, wherein the instructions are further executable by the processor for:
receiving, by the CNN, a text string;
predicting, by the CNN, a class label of the text string.

20. The computer program product of claim 19, wherein the predicting comprises:
generating a DVR of the text string;
comparing the DVR of the text string to the class DVRs in the class embedding matrix to generate a score for each of the classes corresponding to columns in the class embedding matrix;
selecting the highest generated score;
based on the selected score being a positive number, outputting the class label corresponding to the selected score as the predicted class label of the text string; and
based on the selected score being a negative number, outputting the class label of none-of-the-above as the predicated class label of the text string.
